(19) United States
(12) Patent Application Publication
(10) Pub. No.: US 2014/0081783 A1
(43) Pub. Date: Mar. 20, 2014

(54) Push Payment Processor

(71) Applicants: Jagadish Bhalchandra Paranjape, San Jose, CA (US); Mary O'Malley, San Jose, CA (US); Sandy Lynn Godsey, San Jose, CA (US)

(72) Inventors: Jagadish Bhalchandra Paranjape, San Jose, CA (US); Mary O'Malley, San Jose, CA (US); Sandy Lynn Godsey, San Jose, CA (US)

(21) Appl. No.: 13/946,672

(22) Filed: Jul. 19, 2013

Related U.S. Application Data
(60) Provisional application No. 61/701,075, filed on Sep. 14, 2012.

(51) Int. Cl. G06Q 20/40

(52) U.S. Cl. CPC G06Q 20/40
USPC 705/21

(57) ABSTRACT

Embodiments of methods and systems provide transaction processing with dynamic generated codes. In an embodiment, a system comprises a remote server adapted to interact with a POS device and a client device; one or more processors; and one or more memories adapted to store machine-readable instructions to cause the system to: receive, by the server at the remote location, a transaction request from the POS device of the seller, wherein the transaction request includes transaction information in connection with a transaction conducted at the POS device; generate a transaction code upon receiving the transaction request from the POS device, wherein the transaction code includes the transaction information; send the transaction code to the POS device; receive an authorization request for the transaction from the client device after the client device reads the transaction code from the POS device; and process the transaction.

### RELATED APPLICATIONS

The present disclosure claims priority to and the benefit of U.S. Provisional Application Ser. No. 61/701075, which was filed on Sep. 14, 2012, the contents of which are herein incorporated by reference in their entirety.

### BACKGROUND

1. Technical Field

Embodiments of the present disclosure generally relate to transactions, and more particularly, to methods and systems for processing of transactions with dynamic generated codes.

2. Related Art

Customers routinely search for, purchase and pay for products and/or services at merchant locations or over communication networks, such as the Internet. Individual customers may frequently engage in transactions with a variety of merchants at a merchant's Point of Sale (POS), for example, in-store or through various merchant websites. Common ways of making payments at a merchant's location or over the Internet include using a credit card, a debit card, cash, or the like. Routinely, customers may also engage in such transactions by using their mobile devices to make payments. However, typical ways of making payments at a POS may be cumbersome and inconvenient.

### BRIEF DESCRIPTION OF THE FIGURES

FIG. 1 is a block diagram of a transaction system using a payment service provider according to an embodiment of the present disclosure.

FIG. 2A is a flow diagram illustrating a method for push payment processing according to an embodiment of the present disclosure.

FIG. 2B is a communications or message flow diagram according to an embodiment of the present disclosure.

FIG. 3 is a block diagram of a system for implementing a device according to one embodiment of the present disclosure.

Like element numbers in different figures represent the same or similar elements.

### DETAILED DESCRIPTION

In accordance with various embodiments described herein, methods and systems enable a user to easily conduct transactions (e.g., make payments) in connection with applications, products and/or services (“items”) over a client device. A push payment application, which may be loaded on a client device by an entity such as a payment service provider, enables the user to easily conduct transactions on a client device. In one or more embodiments, the push payment application may be provided by an entity such as a merchant or a payment service provider such as PayPal®, Inc. and/or eBay®, Inc. of San Jose, Calif., USA. In one or more embodiments, the push payment application may be provided by an entity such as a Telecom Network Provider. In further embodiments, the push payment application may also be provided by digital goods stores or other entities.

Methods and systems according to one or more embodiments provide push payment processing with dynamic generated codes (e.g., bar codes, QR codes, etc.). In that regard, a server at a remote location such as a payment service provider server may generate a transaction code including a transaction-specific identifier, e.g., an ID code for a specific transaction. In one embodiment, a merchant may send a transaction request to the remote server, e.g., the payment service provider server. The request may include transaction information or identifiers for the transaction such as product, price, store location, date, etc. The payment service provider server may then generate a transaction code such as a QR code for that transaction and send it to a Point of Sale (POS) of the merchant. The merchant may display the code (e.g., QR code) at or near the POS device. A buyer may then read, scan or otherwise enter the transaction code (e.g. QR code) with a user device such as a mobile device. The buyer may authorize a push payment to the merchant by sending a payment authorization (along with the entered transaction code including a transaction ID) to the payment service provider server. The payment service provider server may perform, initiate or confirm payment to both the buyer's user device and the merchant POS. The payment service provider server may also provide a digital receipt to the buyer.

Transactions according to one or more embodiments herein may apply to in-store sales, restaurants, outdoor fairs, delivery agents, etc. A POS device or terminal may be a traditional POS device or terminal such as a cash register, a mobile user device having display capabilities, a delivery confirmation device, or any other POS device appropriate for conducting transactions.

Advantageously, a remote server, e.g., a payment service provider server, may generate dynamic transaction codes, which may be temporary, such as QR codes, bar codes, etc., arid process push payments with the dynamic codes. Such generated codes may include transaction information and may direct to an account to push funding to and from the buyer, without having to direct or link to a website associated with a merchant or other entity that allows payment.

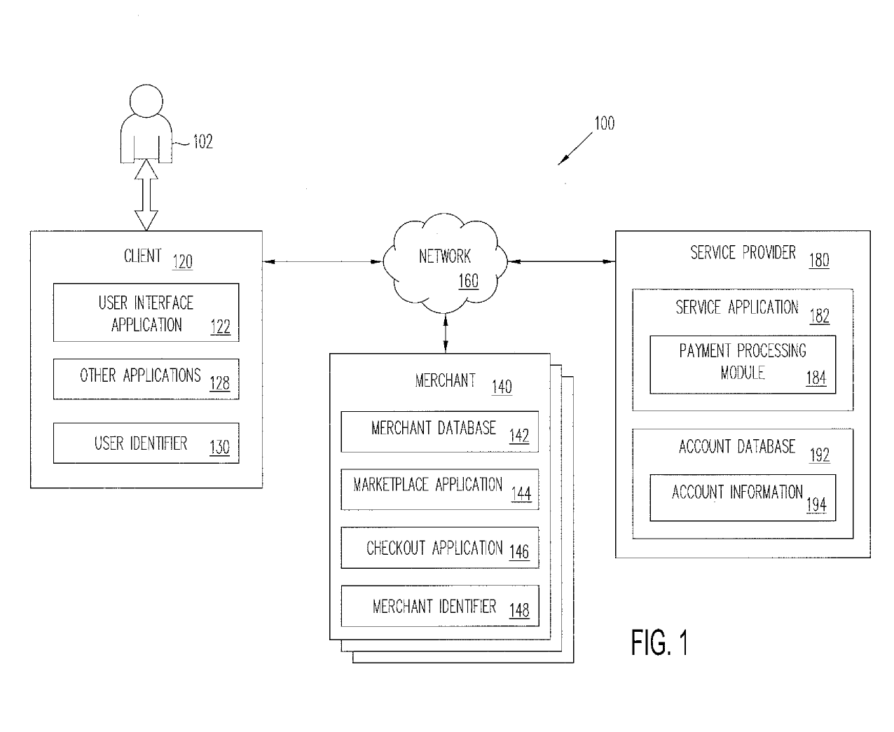

Referring now to the drawings wherein the showings are for purposes of illustrating embodiments of the present disclosure only, and not for purposes of limiting the same, FIG. 1 illustrates a block diagram of a transaction system using a payment service provider according to an embodiment of the present disclosure.

FIG. 1 shows one embodiment of a block diagram of a system 100 adapted to facilitate transactions (e.g. purchase and make payments for items) via a client device 120 of a user 102 over a network 160. As shown in FIG. 1, the system 100 includes at least one client device 120 (e.g., network computing device), one or more merchant servers or devices 140 (e.g., network server devices), and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers or devices 140, and service provider server or device 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In various examples, the client device 120 may be implemented as a wireless telephone (e.g., cellular or mobile phone), a tablet, a personal digital assistant (PDA), a personal computer, a notebook computer, and/or various other generally known types of wired and/or wireless computing devices. It should be appreciated that the client device 120 may be referred to as a user device, a buyer device, or a customer device without departing from the scope of the present disclosure.

The client device 120, in one embodiment, includes a user interface application 122, which may be utilized by user 102 to conduct financial transactions (e.g., shopping, purchasing, bidding, etc.) with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select items for purchase, and the user 102 is able to purchase items from the one or more merchant servers 140 via the service provider server 180. Accordingly, the user 102 may conduct financial transactions (e.g., purchase and provide payment for items) from the one or more merchant servers 140 via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 may include a push payment application that may be loaded on client device 120 by service provider server 180, by merchant server 140, or by any other appropriate entity. Such push payment application enables user 102 to easily conduct transactions (e.g., make payments) for items over client device 120 as will be described herein in further detail.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 130 may be passed with a user login request to the service provider server 180 via the network 160, and the user identifier 130 may be used by the service provider server 180 to associate the user 102 with a particular user account maintained by the service provider server 180.

The one or more merchant servers 140, in various embodiments, may be maintained by one or more sellers or business entities, profit or nonprofit (or in some cases, by a partner of a business entity that processes transactions on behalf of business entities). Examples of business entities include merchant sites or locations, resource information sites locations, utility sites or locations, real estate management sites or locations, social networking sites, etc., which may offer various items for purchase and payment. In some embodiments, business entities may need registration of the user identity information as part of offering the items to the user 102 over the network 160. As such, each of the one or more merchant servers 140 may include a merchant database 142 for identifying available items, which may be made available to the client device 120 for viewing and purchase by the user 102. It should be appreciated that although a user-merchant transaction is illustrated in this embodiment, the system may also be applicable to user-user, merchant-merchant and/or merchant-user transactions.

Each of the merchant servers 140, in one embodiment, may include a marketplace application 144, which may be configured to provide information over the network 160 to the user interface application 122 of the client device 120. For example, the user 102 may interact with the marketplace application 144 through the user interface application 122 over the network 160 to search and view various items available for purchase in the merchant database 142.

Each of the merchant servers 140, in one embodiment, may include a checkout application 146, which may be configured to facilitate online transactions (e.g., purchase transactions) by the user 102 of items identified by the marketplace application 144. As such, in one aspect, the checkout application 146 may be configured to accept payment information from the user 102 over the network 160.

Each of the merchant servers 140, in one embodiment, may include at least one merchant identifier 148, which may be included as part of the items made available for purchase so that, e.g., particular items are associated with particular merchants. In one implementation, the merchant identifier 148 may include one or more attributes and/or parameters related to the merchant, such as business and banking information. As described in greater detail herein, the user 102 may conduct transactions (e.g., selection, monitoring, purchasing, and/or providing payment for items) with each merchant server 140 via the service provider server 180 over the network 160.

The service provider server 180, in one embodiment, may be maintained by a transaction processing entity, which may provide processing for financial transactions and/or information transactions between the user 102 and one or more of the merchant servers 140. As such, the service provider server 180 includes a service application 182, which may be adapted to interact with each client device 120 and/or each merchant server 140 over the network 160 to facilitate the selection, purchase, and/or payment of items by the user 102 from one or more of the merchant servers 140. In one example, the service provider server 180 may be provided by PayPal®, Inc. and/or eBay®, Inc. of San Jose, Calif., USA.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140). For example, account information 194 may include private financial information of each user 102 and each merchant associated with the one or more merchant servers 140, such as one or more account numbers, passwords, credit card information, banking information, or other types of financial information, which may be used to facilitate financial transactions between the user 102 and the one or more merchants associated with the merchant servers 140. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and the user 102 may have credentials to authenticate or verify identity with the service provider server 180. User attributes may include personal information, banking information and/or funding sources as previously described. In various aspects, the user attributes may be passed to the service provider server 180 as part of a login, selection, purchase, and/or payment request, and the user attributes may be utilized by the service provider server 180 to associate the user 102 with one or more particular user accounts maintained by the service provider server 180.

The transaction system described above with respect to the embodiment of FIG. 1 may be used for push payment processing with dynamic generated codes as described in more detail herein.

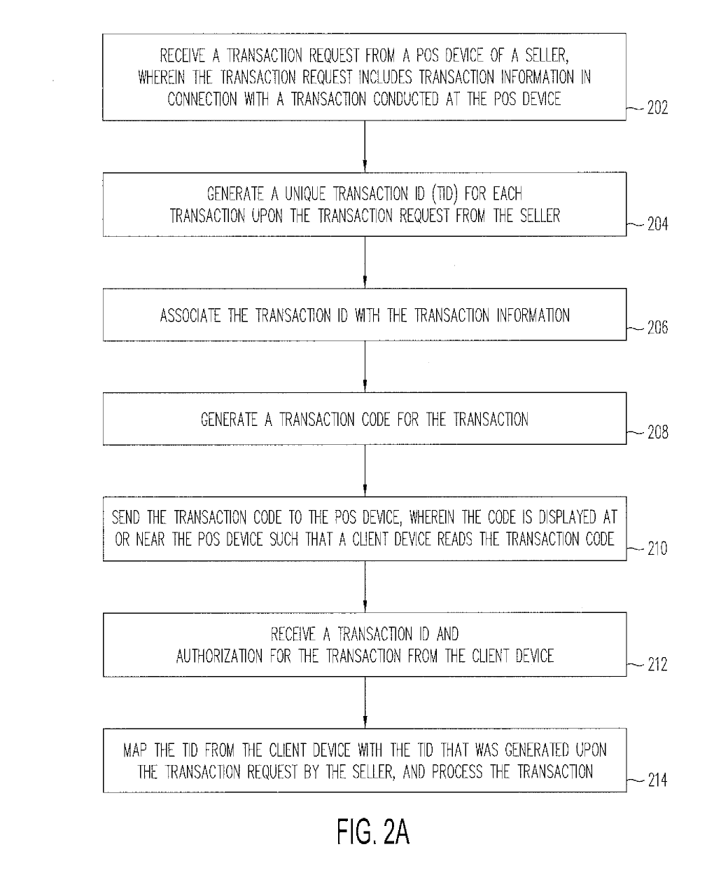

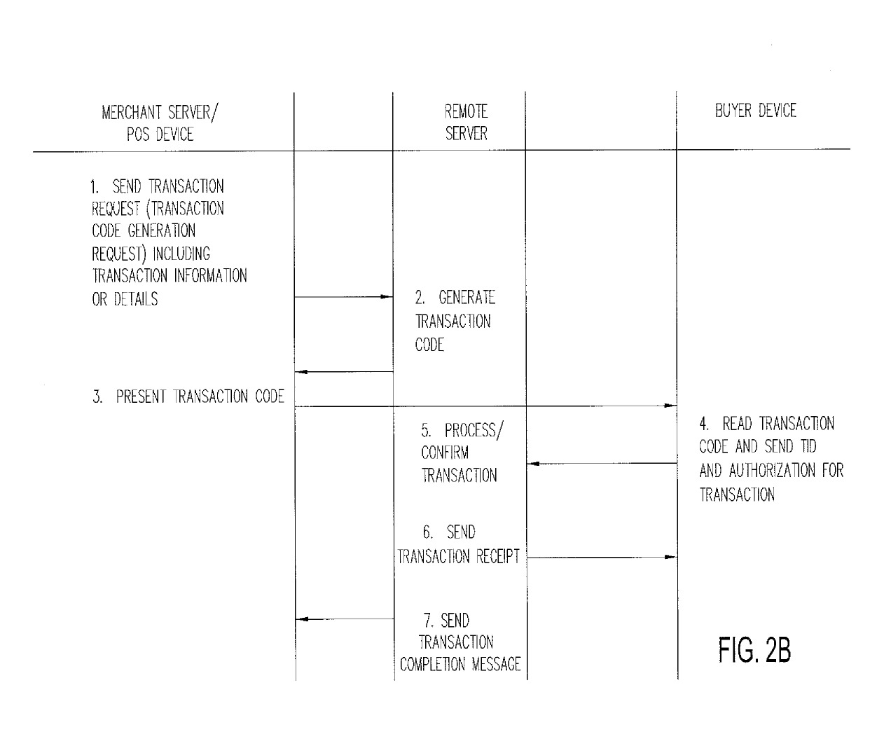

Referring now to FIG. 2A, a flow diagram illustrating a method for push payment processing is illustrated according to an embodiment of the present disclosure. The method of FIG. 2A may be implemented by the system illustrated in FIG. 1 according to one or more embodiments.

As described above according to one or more embodiments, push payments may be processed when an entity such as a merchant deploys a push payment application (POS side deployment) and a buyer device deploys or installs a push payment application (buyer side deployment). In one embodiment, a buyer having a buyer device with a push payment application may select to purchase a particular item from a merchant having a POS side deployment of a push payment application. For instance, upon browsing items offered for sale by the merchant, e.g., via the merchant's website, at a merchant's physical location, etc., the buyer may choose to buy a particular item offered for sale by the merchant. In that regard, the merchant POS may scan, read, or otherwise receive an entry of an item identifier associated with the particular item chosen by the buyer, for example, a UPC of an item. Item identifiers may indicate the type, manufacturer, characteristics (e.g., color, size, etc.) of an item.

The buyer may select to use a remote server such as a payment service provider server (e.g., PayPal®) at the POS of the merchant in order to conduct a transaction (e.g., make payment) in connection with the particular item.

In block 202 of FIG. 2A, a server at a remote location, for example, a payment provider server, receives a transaction request from a seller or merchant via a POS device of the seller. The transaction request may include transaction information in connection with a transaction conducted at the POS device including details such as an item identifier, price, amount, quantity, store identifier, date, etc. The transaction request may also include a unique identifier for the POS, which may be used to associate a transaction with the POS device that requested it.

In block 204, a unique transaction identifier or ID (TID) may be generated at the remote server for each transaction upon the seller's or merchant's transaction request.

In block 206, the unique transaction ID (TID) may be associated with the transaction information. For example, the unique TID is associated with the particular merchant, POS and/or the details of a sale such as the item identifier, price, amount, quantity, store identifier, date, etc. The TID may also be associated with other pertinent information such as deposit and/or invoice information.

In block 208, a transaction code, which may be temporary, may be generated for the transaction. In embodiments herein, the transaction code generated by the remote server includes the TID. Also, when the remote server receives a request from the merchant for a transaction code, the generated transaction code (e.g., QR code) may include transaction information or details, deposit information, invoice information, etc.

In block 210, the remote server may send the transaction code to the POS device. The transaction code may be received and displayed at or near the POS device such that a client device may read the transaction code. For instance, the remote server sends a transaction QR code to the merchant, and the merchant displays the transaction QR code at or near the POS device so that a buyer may use the buyer device to read, scan or otherwise enter the transaction QR code. It should be noted that in various embodiments, the transaction code may be a QR code, a bar code or any appropriate code that may be read, scanned or otherwise inputted by a buyer device. In some embodiments, the transaction code may be in a form that may allow a user of a buyer device to manually input the code into the buyer device or any appropriate device.

In block 212, a transaction ID and authorization for the transaction are received from the client device by the remote server. For example, the remote server may receive the transaction QR code sent from the buyer device to initiate push payment.

In block 214, the TID received from the client device by the remote server may be mapped with the TID that was generated upon the transaction request by the seller, and the transaction may be processed. In that regard, the remote server, e.g., the payment service provider server, may transfer funds to the merchant specified in the transaction code. Also, the remote server may send confirmation of the transaction (e.g. payment) to the merchant server and the buyer device.

Advantageously, in embodiments herein, the transaction code such as the transaction QR code generated by the remote server may include deposit information and invoice information, which may be used to push the payment, and therefore, the transaction QR code may include authorization and transaction information, and is not merely an indicator of a transaction receipt.

In various embodiments, the transaction code may be temporary. A TID Timeout may be used. For example, the server at the remote location (e.g., the payment service provider server) may maintain a timestamp for each TID. The TID may time out after a fixed amount of time has elapsed, for example, after 90 seconds. This timeout value may be long enough to let a buyer device read or otherwise enter the transaction code (e.g., scan the barcode or QR code) and complete the transaction. The timeout value may vary or be set based on the type of transaction.

In various embodiments, the transaction code, which may also be referred to as “Push Payment Code or PPC,” may be a QR code, a barcode or any suitable code or identifier that may be read, scanned, or otherwise entered by a buyer device. A PPC may be unique. For example, one PPC may be generated for each transaction. In an embodiment, a PPC may include only a TID and transaction information or details such as an amount, price, quantity, etc. The PPC may not include any information about the merchant or the buyer or user.

Referring now to FIG. 2B, a communications or message flow diagram is illustrated according to an embodiment of the present disclosure. As described above, communications or messages may flow from one server or device to another, for example, from a merchant server or device 140 (illustrated in the embodiment of FIG. 1) to one or more buyer devices 102 and vice versa, between merchant device server or device 140 and service provider server 180 and vice versa, between buyer device 102 and service provider server 180 and vice versa, etc. Such messages may be generated or transmitted at certain times or upon particular events or triggers (e.g. upon receiving a transaction request). As described above, communications between devices or servers may be made via network 160.

In various embodiments, as described above, a push payment application (which may be referred to as “Push Payments mobile application (PPMA)”), may be installed and ran on a buyer device. That is, a user or buyer may deploy a Push Payments System on the user or buyer device side (buyer side deployment on a buyer device). In that regard, buyers may install a buyer device application provided by a remote server such as PayPal®, or by a seller or merchant, or by any other appropriate entity. Also, as described above, a seller or merchant may deploy a Push Payments System according to one or more embodiments herein, i.e., on the seller or merchant side (POS side deployment). In that regard, the remote server (which may be referred to as “Push Payment Server or PPS”), may provide POS software as a service to entities such as merchants. Once a merchant creates an account with the PPS vendor (e.g. PayPal®), a merchant may simply login to the merchant's account and may start using the POS software that accepts payments using the PPS. The access to the service may be web browser-based so that any commodity computing device such as tablets, smart phones, laptops, desktops, etc. may be used as a POS device. The PPS may expose an API to integrate with existing POS applications. That way, any individual or entity such as a merchant (e.g., a store, a restaurant, or any other business) may easily get access to the PPS.

In an embodiment where a buyer having a buyer device with a PPMA wishes to conduct a transaction in connection with a particular item with a merchant at a POS of the merchant using the PPS, the merchant may scan or otherwise input item identifiers such as a UPC, price, quantity, etc.

Upon conducting a transaction, as illustrated in the embodiment of FIG. 2B, the merchant server or POS device may first send a message with a transaction request (i.e., a transaction code generation request) to the remote server or PPS. The transaction request may include transaction information or details such as an item identifier, price, quantity, etc. For example, the merchant server may send details of the items associated with the transaction.

Second, upon receiving the transaction request from the merchant server or POS device, the PPS may generate a transaction code for the transaction (which may be referred to as “Push Payment Code or PPC”). The PPC may include a transaction identification or ID in addition to transaction information or details. The PPS may then send the transaction code or PPC to the merchant server or POS device.

Third, the merchant may present the PPC at or near the merchant server or POS device such that the buyer device may read, scan or otherwise enter the PPC.

Fourth, the PPMA on the buyer device may read, scan, or otherwise enter the PPC using, for example, a camera or other appropriate input interface of the buyer device. The PPC may then be decoded and sent to the PPS as part of a payment authorization request. In one or more embodiments, the PPC may be decoded by hardware on the buyer device itself, or the PPMA may use an additional remote server for decoding the PPC. The PPS may map the TID received from the buyer device's payment authorization request to the PPC generated upon the seller's or merchant's request. In an embodiment, a transaction initiated by a merchant may be linked with the buyer or user.

Fifth, the server at the remote location or PPS may process and confirm the transaction. For example, the PPS may take steps for transferring funds from the buyer's account to the merchant's account. In various embodiments, the PPC may be temporary. Once the transaction is processed, the PPC may become inactive, i.e., even if the PPMA scans the PPC again, decodes it and sends it to the server at the remote location or PPS, the server at the remote location or PPS may not process it again. As such, the PPC may have one-time scan semantics or features. Advantageously, such one-time scan semantics and TID timeout may minimize risks due to, for example, replay attacks and buyer errors like multiple scans of the same PPC by the buyer.

Sixth, the PPS may generate digital receipts for the transaction and send them to the buyer device. And seventh, the remote server or PPS may send a transaction completion message to the Merchant Server /POS device indicating that the transaction has been processed or completed.

The security of the system may be enhanced in various manners. For example, communications between the various parties such as between the merchant and the client device, the client device and the PPS, etc. may take place over encrypted secure channels and may use protocols such as HTTPS/SSL-TLS with Client Authentication. Also, the PPMA may run in a secure micro virtualization based container that may help isolate a task running in an Operating System.

For authentication and payment authorization purposes, a policy may be implemented according to one or more embodiments. For example, when the PPMA is first activated, a username and a password may be used to authenticate the buyer. The PPMA and the PPS may associate a user with a unique authentication ID (AID). An encrypted AID may be stored at both the PPMA as well as at the PPS. The AID may serve as an authentication token for low amount payments, for example.

In an embodiment, a “low amount payment” may generally be governed by policies. For example, whenever a user authenticates with the PPS using a username and password, a new AID may get associated with the PPMA and the PPS. After that, authentication requirements may be policy based. For example, a policy may require the buyer to re-authenticate with username and password after, for example, every $200 spent.

Payment authorization or approval of transfer of funds by an authenticated user may require a PIN or a Password or a combination of both. In some embodiments, for example for reducing friction on the buyer side, the user authentication policies may change based on an amount being paid. For example, for low amount payments, for example, up to $20, no additional authentication may be required. For any payments between $20 and $100 the PPS may demand a 4-digit PIN. For any payments involving a higher amount, the PPS may demand a password and a pin or other user identifiers.

The authentication policy may be configured by the buyer according to one or more embodiments. For example, a buyer may want every transaction to be authenticated by a 4 digit PIN, or the buyer may want to use a 4 digit pin only when an amount is more than, for example, $10.

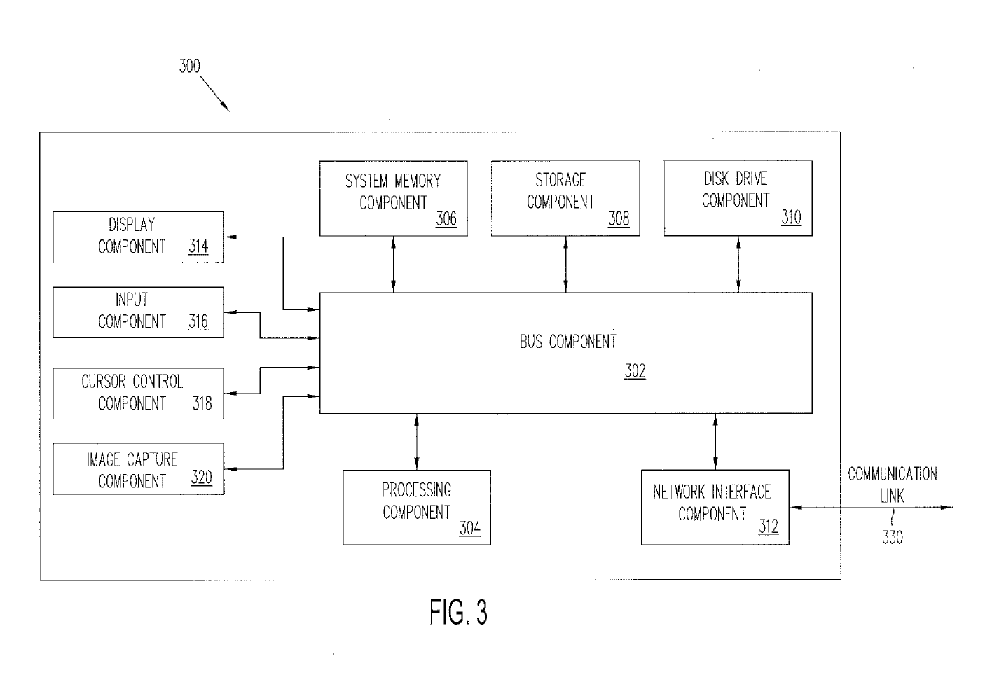

Referring now to FIG. 3, a block diagram illustrates a system 300 suitable for implementing embodiments of the present disclosure, including client device 120, one or more merchant servers or devices 140, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to process financial transactions, make payments, split payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for payments or financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for payment push processing with dynamic generated codes.

Although various components and steps have been described herein as being associated with client device 120, merchant server 140, and payment service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A system comprising:
a server at a remote location adapted to interact with a Point of Sale (POS) device of a seller and a client device over a network;
one or more processors; and
one or more memories adapted to store a plurality of machine-readable instructions which when executed by the one or more processors are adapted to cause the system to:
receive, by the server at the remote location, a transaction request from the POS device of the seller, wherein the transaction request includes transaction information in connection with a transaction conducted at the POS device;
generate a transaction code upon receiving the transaction request from the POS device, wherein the transaction code includes the transaction information;
send the transaction code to the POS device;
receive an authorization request for the transaction from the client device after the client device reads the transaction code from the POS device; and
process the transaction.

2. The system of claim 1, wherein the plurality of machine-readable instructions which when executed by the one or more processors are adapted to further cause the system to:
generate a unique transaction identifier (TID) for the transaction upon receiving the request from the POS device;
associate the unique TID with the transaction information;
send the transaction code to the POS device, wherein the transaction code includes the TID, and the transaction code is presented at or near the POS device, wherein the client device reads the transaction code;
receive the TID and authorization for the transaction from the client device; and
process the transaction upon mapping the TID received from the client device with the TID generated upon receiving the request from the POS device.

3. The system of claim 1, wherein the transaction information further comprises at least one of an item identifier, a price, an amount, a store identifier, and a date.

4. The system of claim 1, wherein the transaction code further comprises a client device-readable code including a QR code or a barcode.

5. The system of claim 1, wherein the plurality of machine-readable instructions which when executed by the one or more processors are adapted to further cause the system to perform, initiate or confirm the transaction to the client device and/or to the POS device of the seller.

6. The system of claim 1, wherein the plurality of machine-readable instructions which when executed by the one or more processors are adapted to further cause the system to provide transaction information including a digital receipt in connection with the transaction to the client device.

7. The system of claim 1, wherein the server at the remote location further comprises a payment service provider server.

8. The system of claim 1, wherein the plurality of machine-readable instructions which when executed by the one or more processors are adapted to further cause the system to maintain a timestamp for the transaction code, wherein the transaction code times out after a fixed amount of time has elapsed.

9. The system of claim 1, wherein the authorization request comprises an authentication policy configured by a user of the client device.

10. A method comprising:
receiving, electronically by a processor, a transaction request from a Point of Sale (POS) device of a seller, wherein the transaction request includes transaction information in connection with a transaction conducted at the POS device;
generating, electronically by the processor, a transaction code upon receiving the transaction request from the POS device, wherein the transaction code includes the transaction information;
sending, electronically by the processor, the transaction code to the POS device;
receiving, electronically by the processor, an authorization request for the transaction from the client device after a client device reads the transaction code from the POS device; and
processing the transaction.

11. The method of claim 10 further comprising:
generating, electronically by the processor, a unique transaction identifier upon receiving the transaction request from the POS device;
associating, electronically by the processor, the unique transaction identifier with the transaction information;
sending, electronically by the processor, the transaction code to the POS device, wherein the transaction code is displayed at or near the POS device, wherein a user reads the transaction code with the client device;
receiving, electronically by the processor, a transaction identifier and authorization for the transaction from the client device; and
processing the transaction upon mapping the transaction identifier received from the client device with the unique transaction identifier generated for the transaction when requested by the POS device.

12. The method of claim 10, wherein the transaction information further comprises at least one of a product identifier, a price, an amount, a store identifier, and a date.

13. The method of claim 10, wherein the transaction code further comprises a client device-readable code including a QR code or a barcode.

14. The method of claim 10, further comprising performing, initiating or confirming the transaction to the client device and/or to the POS device of the seller.

15. The method of claim 10, further comprising providing transaction information including a digital receipt in connection with the transaction to the client device.

16. The method of claim 10, further comprising maintaining a timestamp for the transaction code, wherein the transaction code times out after a fixed amount of time has elapsed.

17. The method of claim 10, wherein the authorization request comprises an authentication policy configured by a user of the client device.

18. A non-transitory computer readable medium on which are stored computer readable instructions and, when executed by a processor, cause the processor to:
receive a transaction request from a Point of Sale (POS) device of a seller, wherein the transaction request includes transaction information in connection with a transaction conducted at the POS device;
generate a transaction code upon receiving the transaction request from the POS device, wherein the transaction code includes the transaction information;
send the transaction code to the POS device;
receive an authorization request for the transaction from the client device after a client device reads the transaction code from the POS device; and
process the transaction.

19. The non-transitory computer readable medium of claim 18, wherein the computer readable instructions, when executed by the processor, further cause the processor to:
generate a unique transaction ID (TID) for the transaction upon receiving the request from the POS device;
associate the unique transaction identifier with the transaction information;
send the transaction code to the POS device, wherein the transaction code includes the TID, and the transaction code is presented at or near the POS device, wherein the client device reads the transaction code;
receive the TID and authorization for the transaction from the client device; and
process the transaction upon mapping the TID received from the client device with the TID generated for the transaction when requested by the POS device.

20. The medium of claim 18, wherein the computer readable instructions, when executed by the processor, cause the processor to perform, initiate or confirm the transaction to the client device and/or to the POS device of the seller.
